(19) United States
(12) Patent Application Publication
(10) Pub. No.: US 2013/0182278 A1
(43) Pub. Date: Jul. 18, 2013

(54) IMAGE FORMING APPARATUS AND JOB CONTROL METHOD

(71) Applicant: Satoshi Tokuda, Shizuoka-ken (JP)

(72) Inventor: Satoshi Tokuda, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/729,703

(22) Filed: Dec. 28, 2012

Related U.S. Application Data
(60) Provisional application No. 61/587,201, filed on Jan. 17, 2012.

(51) Int. Cl. G06F 21/60; G06F 3/12

(52) U.S. Cl. CPC G06F 21/608; G06F 3/1296
USPC 358/1.14; 358/1.15

(57) ABSTRACT

In accordance with an embodiment, an image forming apparatus comprises a display unit, an input unit, a reading unit and a control unit. The reading unit scans an original sheet. The control unit detects whether or not there is a specific pattern image in the scanned image acquired by the reading unit, prohibits the execution of a job related to the original sheet if the specific pattern image is contained in the scanned image, displays a screen for prompting a specific user to input a password on the display unit and accepts no instruction of the user before acquiring the password from the input unit.

### CROSS-REFERENCE TO RELATED APPLICATIONS

This application is based upon and claims the benefit of priority from U.S. Provisional Application No. 61/587,201 filed on Jan. 17, 2012; the entire contents of which are incorporated herein by reference.

### FIELD

Embodiments described herein relate to an image forming apparatus for prohibiting a specific original from being copied.

### BACKGROUND

Conventionally, there is known an image forming apparatus which carries out a print operation by using a ground pattern as a copy-related security and forms, if a sheet added with a ground pattern is duplicated, an image on the sheet output with a prohibition ground pattern appearing on the sheet output.

However, in the approach above, as the print is printed and output, information leakage cannot be prevented.

### BRIEF DESCRIPTION OF THE DRAWINGS

FIG. 1 is a diagram showing an example of the structure of an image forming apparatus.

FIG. 2 is a flowchart exemplarily showing the actions of an image forming apparatus (require to input an administrator password).

FIG. 3 is a flowchart exemplarily showing the actions of an image forming apparatus (only delete a copy-prohibited original).

### DETAILED DESCRIPTION

In accordance with an embodiment, an image forming apparatus comprises a display unit, an input unit, a reading unit and a control unit. The reading unit scans an original sheet. The control unit detects whether or not there is a specific pattern image in the scanned image acquired by the reading unit, prohibits the execution of a job related to the original sheet if the specific pattern image is contained in the scanned image, displays a screen for prompting a specific user to input a password on the display unit and accepts no instruction of the user before acquiring the password from the input unit.

In accordance with an embodiment, an image forming apparatus comprises a reading unit and a control unit. The reading unit scans an original sheet. The control unit detects whether or not there is a specific pattern image in the scanned image acquired by the reading unit, prohibits the execution of a job for the page having the pattern image and allows the execution of a job for the other pages.

The image forming apparatus provided in the embodiment is roughly described below.

1. The image forming apparatus stops reading if an original printed with a copy-prohibited image (a specific ground pattern in the embodiment) is read and then prohibits an output processing.

2. The image forming apparatus terminates a job if an original printed with a copy-prohibited image is read, displays a screen to require the manager (a specific user) to input a password and accept no operation before the manager inputs a password. in the operation-rejecting state, the image forming apparatus rejects the input operation of the user or a job or the instruction of the user.

3. The image forming apparatus outputs a page containing no copy-prohibited pattern and prohibits the output of a page containing a copy-prohibited pattern without terminating the execution of a job when an original printed with a copy-prohibited image is read.

### Embodiment 1

The form of the embodiment is described below with reference to accompanying drawings.

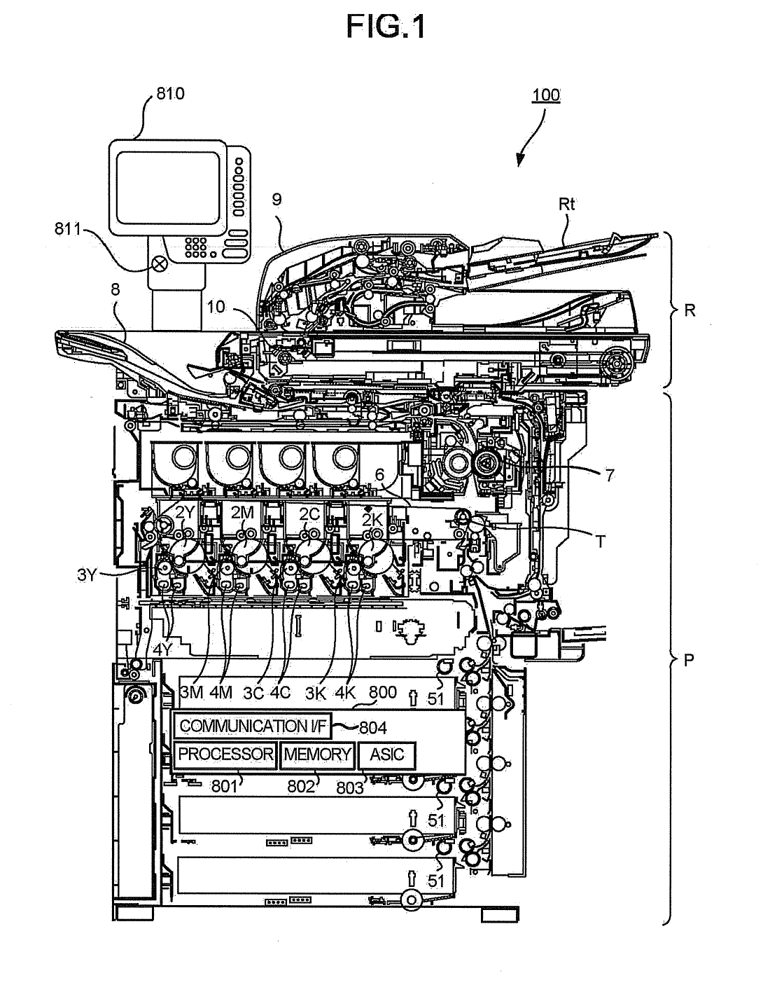

FIG. 1 is a diagram roughly showing the longitudinal section of an image forming apparatus MFP (Multi Function Peripheral) according to an embodiment. As shown in FIG. 1, an image forming apparatus 100 comprises a reading unit R and an image forming unit P.

The reading unit R, which has a function of scanning and reading images of a sheet original and a book original, comprises a scanning optical system 10 provided with a plurality of reflecting lenses and an imaging member and an document ADF9 (ADF: automatic document feeder) 9 for automatically feeding an original to a specified position. The original which is automatically fed to an original tray Rt by the automatic document feeder 9 and the image of an original placed on an original table (not shown) are read by the scanning optical system 10.

The image forming unit P has the following function of forming a developer image on a sheet based on the image read by the reading unit R from an original or the image data sent to the image forming apparatus 100 from a peripheral. Moreover, the image forming unit P comprises photosensitive members 2Y-2K, developing rollers 3Y-3K, mixers 4Y-4K, an intermediate transfer belt 6, a fixing apparatus 7 and a discharge tray 8.

The image forming apparatus 100 includes a control panel (control unit) 800 for comprehensively controlling each hardware in the apparatus. The control panel 800 includes a processor 801, a memory 802, an ASIC 803 (ASIC: Application Specific Integrated Circuit) and a communication I/F 804 (IF: I/F Interface). The processor 801 is an operation processing apparatus such as a CPU (Central Processing Unit) or an MPU (Micro Processing Unit) etc. The processor 801 has a function of realizing various processing of the image forming apparatus 100 and achieves various functions by loading and executing the program pre-stored in the memory 802.

The memory 802 is a memory unit consisting of nonvolatile memory apparatus including an RAM (Random Access Memory) serving as a primary memory apparatus, a flash memory and a hard disk drive. The ASIC 803 is an integrated circuit for specializing an image processing. The communication I/F 804 is a unit comprising a FAX board connected with a public line and an LAN (Local Area Network) board connected with the network 300.

Moreover, the image forming apparatus 100 comprises a control panel 810 which has a touch panel type or keyboard type input unit for accepting an instruction of the user. Besides, the control panel 810 has a flat plate type display (display unit) for displaying the content or information being processed for the user. Further, the control panel 810 is provided with a loudspeaker 811 for outputting, for example, a BEEP sound.

A copy processing is generally described below as an example of a processing carried out by the image forming apparatus 100 according to the embodiment. First, a sheet picked up by a pickup roller 51 is fed into a sheet conveying path. The sheet fed into the sheet conveying path is conveyed towards a given conveying direction by a plurality of pairs of rollers.

Then, images of the sheet originals sequentially and automatically conveyed by the automatic document feeder 9 are read by the scanning optical system 10.

Next, the control plate 800 carries out a specific image processing on the image data read by the reading unit R from the original. Then, electrostatic latent images of the data subjected to the image processing are formed on the photosensitive surfaces of photosensitive members 2Y, 2M, 2C and 2K for transferring developer images (Y (yellow), M (magenta), C (cyan), K (black)) onto a sheet.

Sequentially, the developer stirred by the mixers 4Y-4K of a developing device is fed, by the developing rollers (the called magnet roller) 3Y-3K, to the photosensitive members 2Y-2K on which electrostatic latent images are formed. In such a manner, the electrostatic latent images formed on the photosensitive surfaces of the photosensitive member are developed.

In this way, the developer images formed on the photosensitive members are transferred to the belt surface of the intermediate transfer belt 6 (the called primary transfer) and conveyed, through the rotation of the intermediate transfer belt, to a given secondary transfer position T to be transferred to the sheet conveyed thereto.

The developer images transferred onto the sheet are thermally fixed by the fixing device 7. The developer images are conveyed in the conveying path by a plurality of conveying rollers through the thermally fixed sheet and then sequentially discharged to the discharge tray 8.

Next, the actions carried out by the image forming apparatus 100 to print an original sheet on which a specific ground pattern (copy-prohibited ground pattern) are exemplarily described below. Further, information of the specific ground pattern is imported into the memory 802 in advance. If there is a specific ground pattern on the original sheet, the image forming apparatus 100 prohibits the execution of the job.

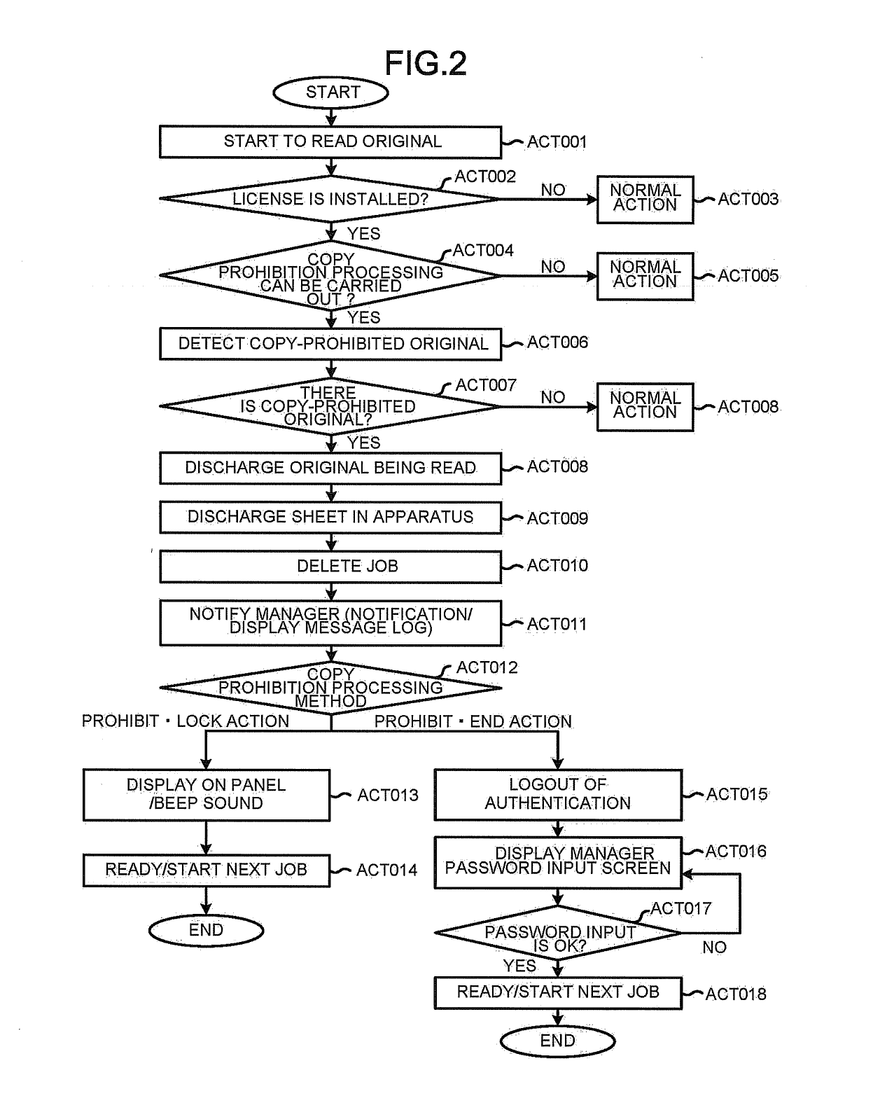

The ground pattern is added to the sheet by a print driver (program) when the computer carries out a printing operation. That is, the print driver adds a specific ground pattern to the document of a copy-prohibited object and then sends the document added with the specific ground pattern to the image forming apparatus 100 (or not). The image forming apparatus 100 prints the document added with the ground pattern. The ground pattern may be any pattern as long as it can be recognized by the prior ground pattern detection algorithm. Further, as different types of jobs, there is a job of copying an original sheet (copy), a job of printing the image data sent from the computer (print) and a job of reading the original sheet to acquire electronic image data (scan) and a job of sending/receiving FAX (FAX) and the like. In the following example, jobs ‘copy’, ‘scan’ and ‘FAX’, are described as processed jobs. Further, the following exemplary actions are carried out after the user logs in the apparatus by inputting personal identification information and a password through the control panel 810. First, the action of requiring the manager to input a password when a specific ground pattern is detected is exemplarily described with reference to the flowchart of FIG. 2. The reading unit R reads an original sheet (ACT 001). After the reading on the original is started, the control panel 800 detects, time and time again, whether or not a specific ground pattern is added using the conventional ground pattern detection algorithm. That is, the detection and the reading are synchronously carried out.

The control panel 800 determines whether or not a license key necessary for the achievement of the function is stored in the memory 802 (ACT 002), and carries out a normal processing without using the function if the license key is not stored in the memory (ACT 002, NO) so as to carry out the conventional job processing (ACT 003). For example, when the job is ‘copy’, a copy operation is carried out directly, and when the job is ‘scan’, the electronic image data is acquired directly. Moreover, when the job is ‘FAX’, a FAX is sent directly.

If a license key is stored in the memory (ACT 002, Yes), the control panel 800 continues to determine which one of copy, scan and FAX the job type of the processed object is (ACT 004). In the embodiment, a control can be carried out by the manager in advance to activate the function when the job type is ‘copy’ or ‘scan’ and deactivate the function when the job type is ‘FAX’. In ACT 004, the control panel 800 carries out the determination by comparing the job type (copy/scan/FAX) with the setting the manager sets in advance. When the job is not a job enabling the effective use of the function (ACT 004: No), a normal action involving no use of the function is carried out (ACT 005).

When the job is a job enabling the effective use of the function (ACT 004, Yes), the control panel 800 detects the original added with the specific ground pattern (copy-prohibited original) (ACT 006). The actions carried out inside the control panel 800 are described in detail below. The ASIC 803 forms RGB data of other 75 dpi thumbnails different from the image (100-600 dpi) , and the processor 801 detects a ground pattern using the data. The detection refers to a software processing. The algorithm for detecting a ground pattern may also be a general pattern matching method or a feature point extraction detection method.

Further, when the scale factor is above 201%, in order to improve detection accuracy, the control panel 800 scans a whole side to produce RGB data. Generally, if the factor is increased, then only the area of the object to be printed corresponding to the increased factor is scanned. Here, as a plurality of ground patterns exist at each position of the original sheet, information containing the original meaning can be acquired when all the patterns are extracted, which leads to a possible leakage of the acquired information when the area of the object is printed. Thus, in the embodiment, a whole side is scanned when the factor is increased.

In ACT 006, the detection on a copy-prohibited original is carried out for all pages involved in the job until a copy-prohibited original is detected. Additionally, the two sides of a sheet may be both printed, and the side of a sheet is referred here to as page. If no copy-prohibited original is detected (ACT 007, No), a normal action is carried out to execute a job directly (ACT 008). If a copy-prohibited original is detected, the automatic document feeder 9 discharges the original being reading in accordance with an instruction from the control panel 800 (ACT 008), and the image forming unit P discharges all the sheets in the apparatus when the original is being printed (ACT 009). The control panel 800 deletes the job being executed (ACT 010). Further, the control panel 800 notifies the manager of the deletion (ACT 011) . The notification may be carried out by sending electronic data to the manager through the communication I/F 804 or outputting a log to the memory 802.

In the example, two prohibition operations may be then carried out in accordance with the setting the manager sets in advance. The control panel 800 reads the setting value defined by the manager to determine which prohibition processing is to be carried out (ACT 012). When the setting value is a value representing ‘prohibit end action’ (ACT 012, prohibit•end action), the control panel 810 displays the read copy-prohibited original in accordance with an instruction of the control panel 800 and gives out a beep sound through the loudspeaker 811. Then, the image forming apparatus 100 gets into a Ready state to execute the next job when the next job is given (ACT 014).

On the other hand, when the setting value of the manager is a value representing ‘prohibit•lock action’ (ACT 012, prohibit•lock action), an output action is prohibited, and the screen of the control panel 810 is locked. Detailed description is given below.

When the user is logged in after passing the user validation, the control panel 800 forces the user to log out (ACT 015). The control panel 810 locks the display and displays a screen for the input of a manager password (ACT 016). In this way, the input of any other information except the password is rejected. The manager inputs a password through the locked screen to remove the locking (ACT 017, Yes), then the image forming apparatus gets into a Ready state (ACT 018).

### Embodiment 2

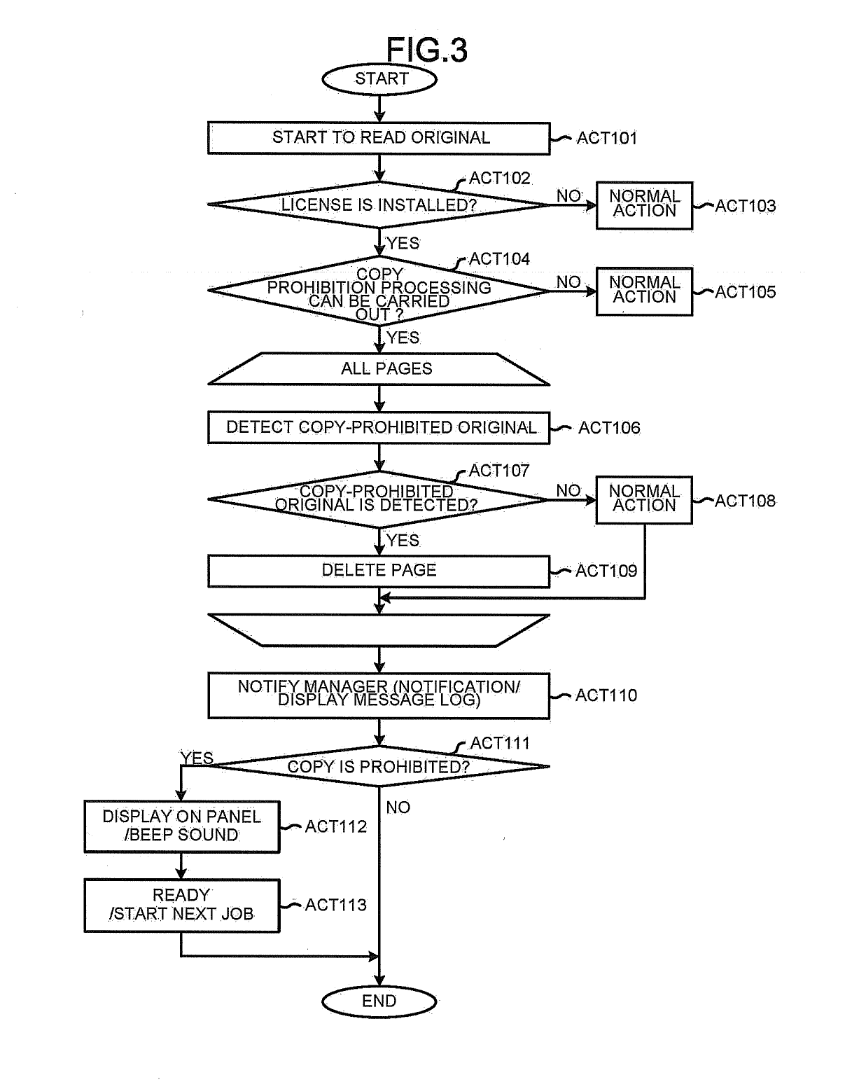

The image forming apparatus provided in embodiment 1 prohibits and ends the output of all the pages involved in a job when a copy-prohibited original is detected. The image forming apparatus provided in this embodiment continues the reading action until the last page is read even if a copy-prohibited original is detected in the reading process. When a copy-prohibited original is detected, the image forming apparatus provided in this embodiment deletes the page containing the copy-prohibited original and outputs the other pages in which no copy-prohibited original is detected. The actions of the image forming apparatus provided in this embodiment are exemplarily described with reference to the flowchart of FIG. 3. In addition, the structure of the apparatus is the same as that of the apparatus provided in embodiment 1 and is therefore not described herein (refer to FIG. 1). Moreover, reference numerals in embodiment 1 denote the same parts of the apparatus provided in this embodiment. ACT101-ACT105 are the same as ACT 001-ACT005 described in embodiment 1. If the result of the determination carried out in ACT 104 is YES, the control panel 800 first detects a copy-prohibited original in original pages in the way described in ACT 006. If no specific ground pattern (copy-prohibited ground pattern) is added to the page (ACT 107, No), the control panel 800 carries out a job processing (copy/scan/FAX) on the page (ACT 108). Then, a copy-prohibited original detection processing is carried out on the following page.

On the other hand, if a specific ground pattern is added to the page (ACT 107, Yes), the control panel 800 deletes the page (ACT 109). In this way, the execution of the job on the page is prohibited, and then ACT 106 is carried out on the following page. ACT 106-ACT 109 are carried out on the first page to the last page involved in the job.

When the job is ended, a notice is sent to the manager (ACT 110), like in ACT 011 described in embodiment 1. The notice is given no matter whether or not a copy-prohibited original is detected, but it is certainly allowed to give the notice only when a copy-prohibited original is detected. Moreover, when a copy-prohibited original is detected (ACT 111, Yes), the control panel 810 displays content ‘copy-prohibited original is detected’, gives out a BEEP sound and displays the number of original pages and the number of the finally output pages (ACT 112) on a popup window. The image forming apparatus 100 gets into a Ready state (ACT 113). If no copy-prohibited original is detected in all pages (ACT 111, Yes), the processing is ended without displaying any content specially.

In addition, ACT 012-ACT018 described in embodiment 1 may be carried out after ACT 110. Moreover, the forms of embodiments 1 and 2 may be combined if no problem is caused in processing.

A group pattern is exemplarily described as a specific pattern image in the embodiments above, however, the specific pattern image can be any pattern image such as machine-readable codes (e.g. barcode, QR code) or a specific string, but not limited to a group pattern. Additionally, the pattern image is an image recognizable to human eyes or an image unrecognizable to human eyes but recognizable to a machine.

In this embodiment, the functions of the present invention are prerecorded in the apparatus, however, the present invention is not limited to this, the same functions may also be downloaded to the apparatus from a network or stored in a recording medium and then installed in the apparatus. The recording medium may be any recording medium (e.g. CD-ROM) which is capable of storing programs and readable to the apparatus. Further, the function achieved by an installed or downloaded program can also be achieved by the cooperation with an OS (Operating System) in the apparatus.

As stated in the detailed description above, copy-related security can be improved by using the technology disclosed herein.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a display unit;
an input unit;
a reading unit configured to scan an original sheet; and
a control unit configured to detect whether or not there is a specific pattern image in the scanned image acquired by the reading unit, prohibit the execution of a job related to the original sheet if the specific pattern image is contained in the scanned image, display a screen for prompting a specific user to input a password on the display unit, and accept no instruction of the user before acquiring the password from the input unit.

2. The image forming apparatus according to claim 1, wherein
the specific pattern image is the image of a specific ground pattern.

3. The image forming apparatus according to claim 2, wherein
the reading unit scans a whole side of the original sheet if the job is to scale up the original sheet and process the scaled-up original sheet.

4. The image forming apparatus according to claim 1, wherein
the control unit carries out a logout of the user who instructs a executing of the job if there is a specific pattern image.

5. The image forming apparatus according to claim 1, wherein
the control unit prohibits a processing for all pages in the job if there is any page including the specific pattern image in the job.

6. The image forming apparatus according to claim 1, wherein
the control unit prohibits a processing for the page having the specific pattern image and allows a processing for the other pages if there is any page including the specific pattern image in the job.

7. The image forming apparatus according to claim 1, wherein
the control unit sets the image forming apparatus to be able to execute the next job if the password is acquired from the input unit.

8. An image forming apparatus, comprising:
a reading unit configured to scan an original sheet, and
a control unit configured to detect whether or not there is a specific pattern image in the scanned image acquired by the reading unit, prohibit the execution of a job for the page having the pattern image and allow the execution of a job for the other pages.

9. The image forming apparatus according to claim 8, wherein
the specific pattern image is the image of a specific ground pattern.

10. A method for controlling the execution of a job of an image forming apparatus, comprising:
scanning and reading an original sheet;
detecting whether or not there is a specific pattern image in the scanned image acquired;
prohibiting the execution of a job related to the original sheet if there is a specific pattern image in the scanned image acquired;
displaying a screen for prompting a specific user to input a password on the display unit; and
rejecting any operation before the password is acquired from the input unit.
